(19) United States
(12) Patent Application Publication
(10) Pub. No.: US 2026/0225100 A1
(43) Pub. Date: Aug. 6, 2026

(54) SAMPLING DEVICE

(71) Applicant: Swansea University, Swansea (GB)

(72) Inventors: Kar Seng Teng, Swansea (GB); Siamak Samavat, Swansea (GB)

(21) Appl. No.: 19/149,474

(22) PCT Filed: Jan. 18, 2024
(86) PCT No.: PCT/GB2024/050132

§ 371 Date: Jul. 18, 2025

(30) Foreign Application Priority Data
Jan. 20, 2023 (GB) 2300887.3

(51) Int. Cl. B01L 3/00

(52) U.S. Cl. CPC B01L 3/5029; B01L 2200/025; B01L 2200/141; B01L 2200/16; B01L 2300/042; B01L 2300/044; B01L 2300/0663; B01L 2300/0672; B01L 2300/087; B01L 2400/0457

(57) ABSTRACT

The invention concerns a sampling device for performing analysis of a sample in a manner that safeguards against contamination or infection; a reader for use in combination with said sampling device; a method for performing analysis of a sample involving the use of said device and reader; and a kit of parts comprising at least one, and ideally a plurality of the said, sampling devices and its associated reader and, optionally a wand swab.

### CROSS REFERENCE TO RELATED APPLICATIONS

This is the U.S. National Stage of International Application No. PCT/GB2024/050132, filed Jan. 18, 2024, which was published in English under PCT Article 21(2), which in turn claims the benefit of GB Application No. 2300887.3, filed Jan. 20, 2023, which is incorporated herein in its entirety.

### FIELD OF THE INVENTION

The invention concerns a sampling device for performing analysis of a sample in a manner that safeguards against contamination or infection; a reader for use in combination with said sampling device; a method for performing analysis of a sample involving the use of said device and reader; and a kit of parts comprising at least one, and ideally a plurality of the said, sampling devices and its associated reader and, optionally a wand swab.

### BACKGROUND OF THE INVENTION

When working with highly contagious and/or dangerous pathogens, particularly when assaying for their presence, it is extremely important to ensure that a sample suspected of containing same is handled in a highly controlled and careful manner to ensure that investigators or researchers are not exposed to any avoidable risks.

Further, when working with a sample that may be hard to come by such as an ancient organic sample, or one that contains only a very small amount of an item to be detected, it is important that the sample is not wasted in any way with a view to maximising the information that can be gleaned from establishing the content of the sample.

In both of these instances, it is desirable to provide a sampling device that efficiently and safely brings together the sample and a substance, typically one or more reagents in liquid or flow-form, that is used to detect in said sample an item of interest and then ensure the substance, which after contact with the sample either contains the item of interest (such as a marker including biomarkers, analytes or the like) or is modified by the item of interest in a way that it can be detected, is available for subsequent analysis by a reader.

There is also a need to provide safe Point of care tests (POCT) for ‘near patient’ diagnostic tests performed outside the routine analytical laboratory. A POCT carried out near the patient is advantageous as it can potentially provide rapid results which enable medical practitioners to act sooner, save lives, improve patient outcomes and reduce overall costs to the healthcare system. We have therefore developed such a sampling device and an associated reader to enable a sample suspected of containing a highly contagious and/or dangerous pathogens or precious data content to be safely and efficiently analysed without risk of contamination, infection, or loss of information. Our sampling device involves the use of a flow-through system in a single-use, disposable cartridge.

### STATEMENTS OF INVENTION

According to a first aspect of the invention there is provided a cartridge for analyzing a sample comprising a single flow path segmented into at least three compartments and comprising:
a first compartment comprising at least one substance for interacting with an item in a sample to be analyzed wherein said compartment is upstream of and in fluid communication with a reaction chamber but separated therefrom by a pierceable membrane or film;
a second compartment comprising a reaction chamber adapted to accommodate a sample swab wherein said compartment comprises at least one movable shutter to control the retention of substance and/or sample in said reaction chamber; and
a third compartment which is downstream of the reaction chamber, and through which said substance flows after having had contact with said sample, and which comprises a sensor strip on which said substance is analysed by a reader.

In a preferred embodiment said single flow path flows from, in use, the top to the bottom of the cartridge so that flow of said substance is aided by gravity. The flow path may be linear, straight, or circuitous but, nevertheless, flows from a first to a second end of said cartridge. In the specific embodiment described herein the single flow path traces a path from a first upper side of said cartridge to a central part of said cartridge and finally to a lower side of said cartridge. Other flow paths, flowing from top to bottom of the cartridge, are included in the working of the invention. Further additional compartments may be included in the single flow path.

Further still, in a preferred embodiment said first compartment comprises an aperture, or air hole, providing a passage between the first chamber and atmosphere. In this arrangement, when the substance flows to the second chamber, the air hole allows air to enter the first chamber and prevent a vacuum forming thus promoting flow of the substance.

In yet a further preferred embodiment, the cartridge further comprises a removable cap or lid, to retain sterility of the first and/or second compartment and/or prevent spillage of the reagent via the air hole. Ideally, the lid is positioned over the cap member, most ideally comprising one or more stopping members to seal the air hole and/or first and/or second compartment when not in use.

In a further preferred embodiment of the invention said first compartment is slidably engaged within the cartridge and so comprises an upper cap member which can be depressed to move further into the cartridge. In use this compartment holds at least one substance for detecting an item in a sample to be analyzed. A side of this compartment, ideally the base, is made of a pierceable membrane or film and located below same, in said cartridge, is a piercing member, such as a blade, positioned so that, as the first compartment slides within or into the cartridge, the blade makes contact with the membrane or film piercing same and so allowing the substance in compartment one to flow through to the second compartment and more particularly the reaction chamber forming part of same. This action thus represents the start of the assay procedure. To facilitate this action a stopping or abutment member is provided on the upper cap member, and it is adapted to engage with a co-operating member provided in the cartridge whereby depression of the cap member results in a downward action that terminates in engagement of the stopping or abutment member with the co-operating member. In this way the degree of insertion of said cap member in said cartridge is controlled.

In a further preferred embodiment of the invention said second compartment comprises a reaction chamber whose cavity accommodates a sample swab, ideally it is elongate with a circular cross-section. This cavity shape is particularly preferred where the substance in the first compartment is used to perform a biological assay and so identify an analyte, such as a pathogen, in a sample and so the swab is a collection member at the end of a stick or wand. Other cavity shapes are envisaged in the working of the invention provided they accommodate the sample swab. More preferably this compartment has a lower part that is fashioned to include at least one and ideally a plurality of agitators for mixing said substance with said sample on said swab, ideally said agitator comprises at least one fin(s) provided on the internal wall of the reaction chamber and preferably adapted for relative sideways or arc/twist-movement, ideally of a back-and-forth nature, with respect to said swab, so that said fin can mix said substance with said sample on said swab. Accordingly, preferably, said second compartment is movably housed within said cartridge whereby the agitator(s) forming part of same can move back-and-forth to form a mixing action. Additionally, or alternatively, and most preferably, one or more agitators are provided on a movable shutter. In an alternative working of the invention said swab is moved by a user across said fin(s) and so the mixing is of a manual nature.

In yet a further preferred embodiment of the invention said movable shutter is also adapted to move within said cartridge in an up-down, circular, sideways, or twisting motion, so acting as a retainer to prevent substance within the reaction chamber from leaving same until the shutter is opened. In the instance where the shutter is provided with an agitator it may have two forms of motion: a first form which enables mixing and a second form which allows the shutter to be opened. The first form of motion may represent a smaller form of the same movement as the second form of motion. Thus, twisting of the shutter by a small degree may be used to mix substance in the reaction chamber whereas rotation through a larger angle may result in opening of the shutter. In the alternative the reaction chamber may be mounted in the cartridge for more than one type of motion, such as twisting to enable mixing and up-down movement to enable the lifting of the shutter and so opening of a passage for the fluid in the reaction chamber to pass to the third compartment.

In a further preferred embodiment of the invention said third compartment comprises a sensor strip which is preferably mounted within said cartridge so as to be flush with the sides of same. Preferably this sensor strip includes a sensing window through which said substance can be assessed by a reader adapted to detect the content or form of said substance, after having contacted said sample.

Preferably, said sample is any sample having an analyte of interest, such as a biological sample, environmental sample, or the like, most preferably a biological sample, typically but not exclusively, isolated from a body of a subject including, but not limited to, a cell, a population of cells, a biopsy, a tissue, an organ, blood, plasma, serum, sputum, peritoneal fluid, CSF, synovial fluid, sperm, breast milk, bronchial lavage fluid, amniotic fluid, malignant ascites, pleural fluid, seminal fluid, tears, urine, faeces and saliva.

Alternatively, said biological sample may be a cell line or the supernatant fluid from cells maintained in culture medium.

In a further preferred embodiment of the invention said substance refers to any substance or reagent that can bind, reversibly or irreversibly, to a target, such as an analyte in said sample (by capturing it from the sample). In this manner, as will be appreciated by those skilled in the art, a sample having, or suspected of having, the target therein is added, by a user, to said reaction chamber where, said target (if present) is specifically recognized and bound by the substance, such that the substance can be used to identify and/or quantitate the target.

In a preferred embodiment of the first aspect of the invention, said substance and/or sensor strip comprises a capture reagent including, but not limited to, antibodies, aptamers and fragments thereof, oligonucleotides or other specific ligands or receptors comprising a specific binding partner for the target analyte in the sample.

In a further preferred embodiment of the invention, said capture reagent is bound directly onto at least a part of a surface of the sensor strip by any means known to those skilled in the art, such as but not limited to, immobilization by adsorption or by chemical coupling. Alternatively, said capture reagent is bound indirectly onto at least a part of a surface of the sensor strip using an anchor substance that binds the capture reagent. Therefore, in this embodiment at least a part of the surface of said sensor strip is coated with the anchor substance and said capture reagent comprises a binding partner that binds the anchor substance. Most ideally, said anchor substance is selected from the group comprising: avidins, oligo and polynucleotides, proteins or lectins which bind a binding partner on the capture reagent and therefore cause the capture reagent to bind to at least a part of a surface of the sensor strip.

It will be appreciated by one skilled in the art that the substance is selected having regard to the nature of the assay to be performed and so the item of interest in the sample to be identified. Thus, the substance may comprise one or more reagents designed to detect the item of interest.

According to a second aspect of the invention, there is provided a reader adapted to engage with said cartridge herein described whereby the sensing window on the sensor strip is aligned with a part of the reader adapted to detect at least one feature of the said substance indicative of the presence or absence of an item of interest in the sample.

Preferably the cartridge and the reader are adapted to mate theretogether in a complementary fashion. For example, the cartridge may be inserted into, placed on, or attached to, the reader and the reader may comprise docking means, such as a slot, or alignment means to enable the cartridge to be inserted, placed, or attached appropriately to the reader.

In a preferred embodiment of the second aspect of the invention, said reader comprises a detector for detecting an item of interest in the substance. As will be appreciated by those skilled in the art, the nature of the detector will vary depending upon the nature of the item of interest. For example, changes in fluorescence intensity or wavelength can be monitored using a fluorimeter and analogous changes in chemiluminescence monitored using a luminometer. Most ideally, said detector is an optical detector for measuring light emission. Alternatively, the detector comprises a potentiostat to perform electrochemical impedance spectroscopy at the sensor. It can also be used to perform other electrochemical techniques, such as cyclic voltammetry, open circuit potential and Differential pulse voltammetry (DPV).

According to a third aspect of the invention, there is provided a kit of parts comprising the cartridge as herein disclosed and a reader adapted to engage with said cartridge whereby the sensing window on the sensor strip is aligned with a part of the reader adapted to detect at least one feature of the substance indicative of the presence or absence of item of interest in the sample.

In a further preferred embodiment, said kit further comprises at least one wand swab, optionally provided with an upper break point in the wand.

According to a further aspect of the invention there is provided a method for performing sample analysis comprising:
i) inserting a sample swab into a part of a single flow path in a cartridge wherein said single flow path is segmented into at least three compartments comprising:
   a first compartment comprising at least one substance for interacting with an item in a sample to be analyzed wherein said compartment is upstream of and in fluid communication with a reaction chamber but separated therefrom by a pierceable membrane or film;
   a second compartment comprising a reaction chamber adapted to accommodate a sample swab wherein said compartment comprises at least one movable shutter to control the retention of substance and/or sample in said reaction chamber; and
   a third compartment which is downstream of the reaction chamber, and through which said substance flows after having had contact with said sample, and which comprises a sensor strip on which said substance is analysed by a reader.
ii) releasing said substance from said first compartment by piercing said membrane or film so that said substance flows into said second compartment;
iii) optionally, mixing said substance with said sample;
iv) moving said shutter of said second compartment whereby said substance flows into said third compartment and onto said sensor strip;
v) placing said cartridge in a reader adapted to detect a feature of said substance indicative of an item of interest in said sample and where said feature is recognized concluding said item of interest is present in said sample.

Preferably, said sample is any sample having an analyte of interest, such as a biological sample, environmental sample, or the like, most preferably a biological sample, typically but not exclusively, isolated from a body of a subject including, but not limited to, a cell, a population of cells, a biopsy, a tissue, an organ, blood, plasma, serum, sputum, peritoneal fluid, CSF, synovial fluid, sperm, breast milk, bronchial lavage fluid, amniotic fluid, malignant ascites, pleural fluid, seminal fluid, tears, urine, faeces and saliva.

Alternatively, said biological sample may be a cell line or the supernatant fluid from cells maintained in culture medium.

In a further preferred method of the invention part i) involves inserting a sample swab into said reaction chamber.

More preferably still, part ii) involves inserting an upper end cap containing said first compartment into said cartridge thus bringing the membrane or film into contact with the blade and so piecing same.

Yet more preferably part iii) is undertaken manually by using a wand of said swab to stroke said sample against said fin(s) or in the alternative, where said reaction chamber or shutter is movably mounted in said cartridge moving same with respect to said sample.

Where manual mixing is undertaken said wand of said swab includes a break point, ideally an upper break point, so that the lower part of said swab can be wholly contained within the cartridge and so disposed of when the cartridge is disposed of. This is particularly favored when assayed dangerous samples.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The Invention will now be described by way of example only with reference to the Examples below and to the following Figures wherein:

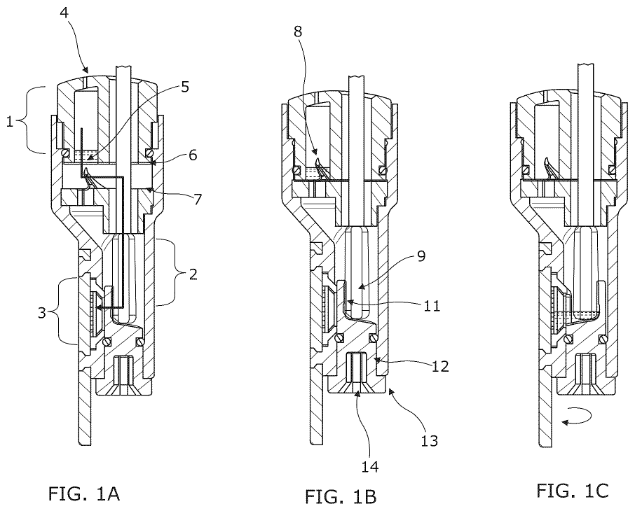

FIGS. 1A-1C. Shows a side sectional view of a cartridge for use according to the invention; A)-C) show the step wise operation of the cap member and so the flow of substance from a first to a second compartment of the cartridge according to the invention;

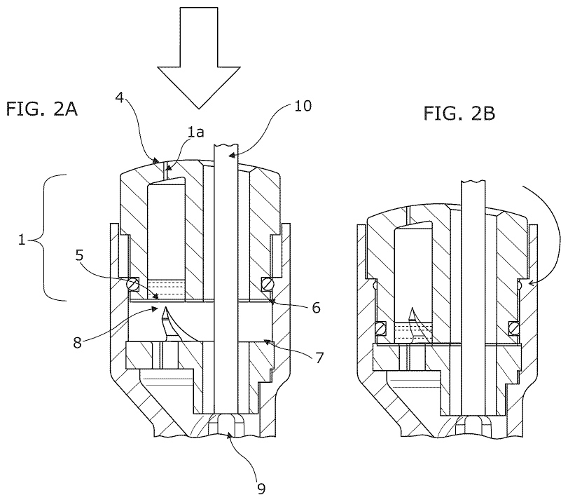

FIGS. 2A-2B. Shows an enlarged side sectional view of the cap member of the cartridge for use according to the invention as shown in FIGS. 1A-1C.

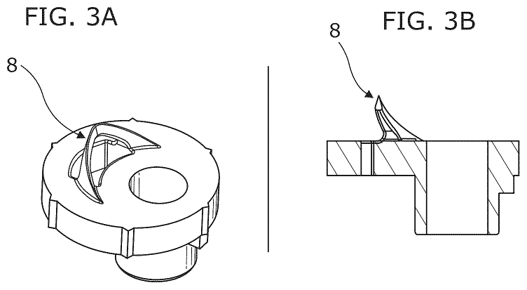

FIGS. 3A-3B. Shows a side sectional view of the piecing member of the cartridge.

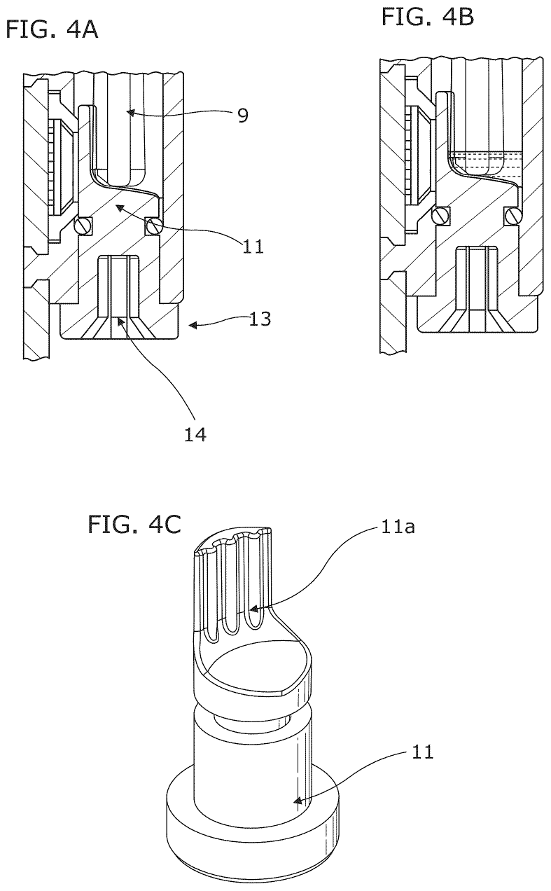

FIGS. 4A-4C. (A-B) Shows a side sectional view of a cartridge for use according to the invention demonstrating the structure of the second compartment. (C) A perspective view of a shutter is also shown.

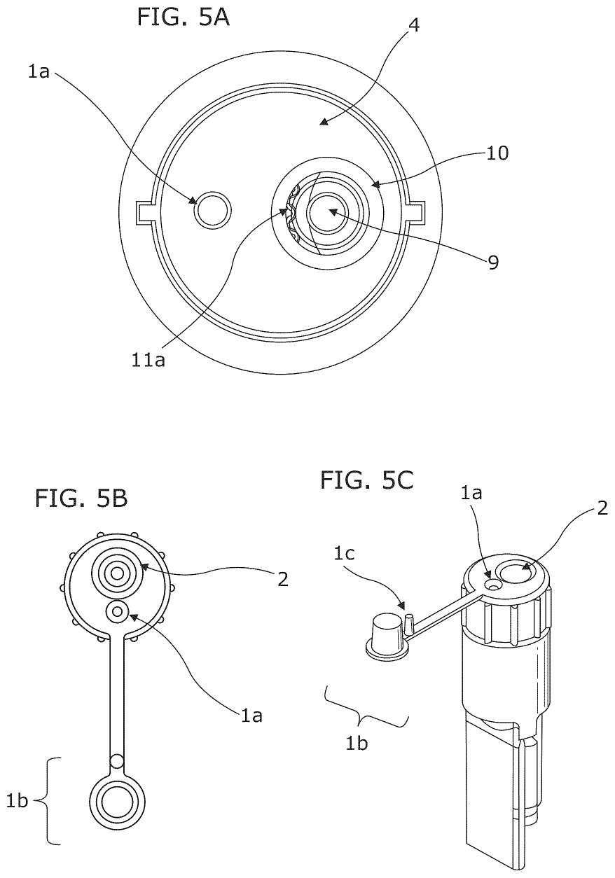

FIGS. 5A-5C. (A) shows a plan view of the cap member of the cartridge, including the second compartment of the cartridge and air hole according to certain embodiments. (B) shows a plan view of the cap member of the cartridge including a lid. (C) a perspective view of the cartridge including the cap is shown.

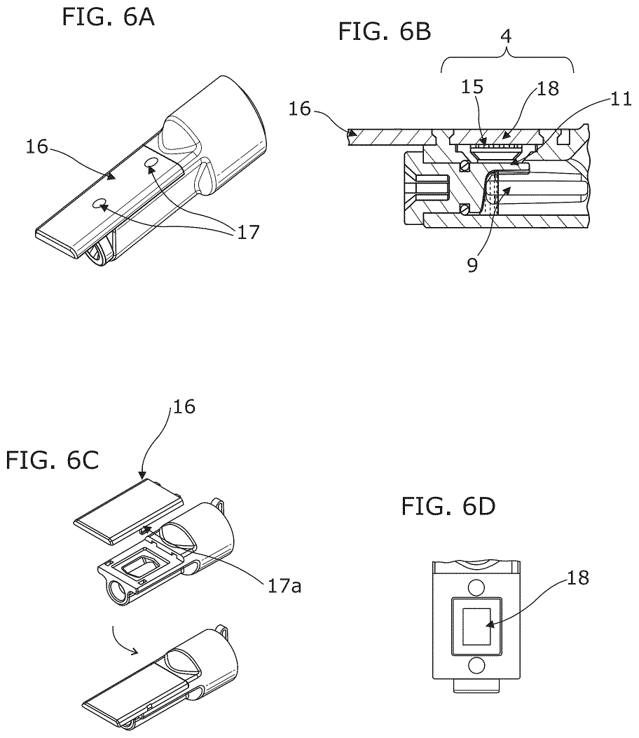

FIGS. 6A-6D. Shows a perspective view (A & C) and a side sectional view (B) and an underside view (D) of the third compartment of the cartridge.

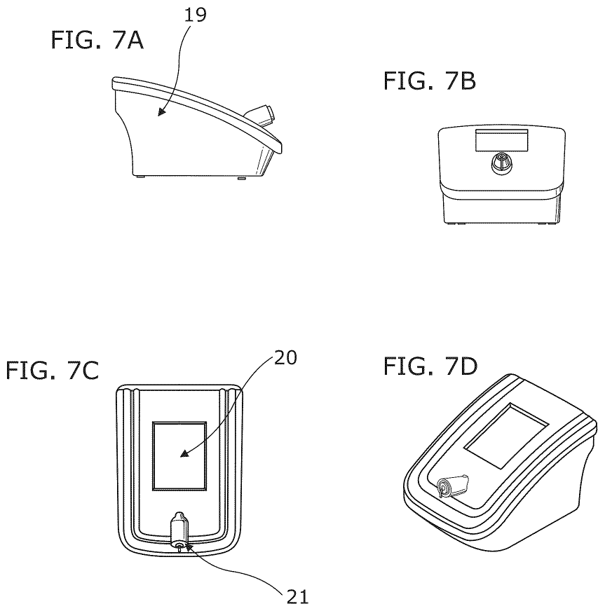

FIGS. 7A-7D. shows a side elevation, front elevation, top elevation/plan and perspective view of a reader for use with a cartridge of the invention.

Referring now to the figures and, firstly, to FIGS. 1A-1C there is shown a side sectional view of a cartridge, comprising a single flow path (indicated by the red arrow) and including segmented first (1), second (2) and third compartments (3). Compartments one to three (1, 2, 3) are positioned in a sequential manner and in fluid communication whereby the single flow path flows from compartments 1 to 2 to 3.

First compartment (1) is circular in cross-section and is provided in an upper cap member (4), in this embodiment of the invention the first compartment (1) is located off-centre of cap member (4), although in some embodiments it could be annular. The first compartment (1) is also located to the side of the second compartment (2) also provided off-centre of the cartridge.

First compartment (1) includes a lower side provided by a pierceable membrane (5) and an upper side including an abutment ring (6) adapted to mate in motion-limiting fashion with a rim (7) provided in the chamber accommodating cap member (4). Further below membrane (5) is positioned a blade (8), in the embodiment shown, blade (8) is sat on top of a circular supporting member. An illustration of the supporting member and integral blade (8) is shown in FIGS. 3A-3B. In a preferred arrangement, first compartment (1) comprises an aperture (1a), or air hole, providing a passage between the first compartment and atmosphere. This is best seen with reference to FIGS. 2A-2B and 5A-5C. In this arrangement, when the substance flows to the second compartment or reaction chamber, the air hole allows air to enter the first compartment and prevent a vacuum forming, thus promoting flow of the substance. As will be appreciated, the first compartment may further include a lid (1b), ideally positioned to cover the air hole (1a) and/or second compartment (2), to retain sterility when not in use and also to prevent leakage of the reagent/mixtures (not shown). Ideally, this is positioned over cap member (4). In a preferred arrangement, the lid (1b) comprises one or more stopping members (1c) for insertion into the air hole and/or second compartment to seal the chambers.

Thus, as depicted in FIGS. 1A-1C and FIGS. 2A-2B, in use, when cap member (4) is depressed and so moves further within the cartridge, blade (8) makes contact with membrane (5) and pierces same thus allowing substance in the first compartment (1) to flow through the single flow path to the second compartment (2) housing reaction chamber (9).

A pierceable aperture (10) is provided off-centre in cap member (4) (as can be seen in FIGS. 5A-5C), and aligned with lower reaction chamber (9), it is of roughly the same size and shape as reaction chamber (9) and is adapted to receive a wand type swab. Therefore, in use a swab can be placed in the cartridge, more specifically the second compartment, before or after the blade (8) is used, depending upon whether the reaction chamber (9) is to be filed with a detecting solution, or substance, before or after the swab is inserted.

These few simple manual manipulations of the cartridge enable a sample swab to be placed in the cartridge and a reaction to take place between a sample and a substance in the reaction chamber (9).

An opening (not shown) in the second compartment (2) is separated from the third compartment (3) by the use of a shutter (11) which is adapted for rotation via lower annular hinge/ring (12) which is accessible for manual rotation via part (13) which extends beyond the lower part of the cartridge. To facilitate the mixing in the mixing chamber (9), the second compartment (2) is provided, on an inner side thereof with agitators or fins (11a). These fins (11a) may be on the mixing chamber wall and/or the surface of the shutter (11). Shutter (11) sits partially outside the second compartment (2) and acts as a gateway preventing the content of the reaction chamber (9) from passing to compartment 3. Shutter 11 has an interface fit with compartment 2, until the shutter (11) is displaced by rotation of shutter (11) within the housing of the cartridge (FIG. 1C). In the illustrated embodiment of the invention shutter (11), on its inner side is provided with fins (11a), best shown having regard to FIG. 4C or 5A-5C. In use, the shutter can be moved to mix the sample with the substance. Typically, the shutter or a swab is gently swished back-and-forth to agitate a solution in reaction chamber (9).

The lower part of cartridge is provided with a hexagonal fitting (14) which locates the cartridge within a reader. Ideally shutter (11), annular hinge (12) and hexagonal fitting (14) form part of a single structure so that when the cartridge is located in a reader a motorised engagement member mates with hexagonal fitting (14) and rotates same by 180° thus resulting in shutter 11 being moved to a position 180° away from the opening in the second compartment (2), thus allowing solution or substance therein to flow to the third compartment (3). In certain embodiments the motorised engagement member will not initiate without the sensor chip in place. Ideally, the motorised component only activates once electrical contact is made between the sensor strip and contact pins on/in the reader as a result of the sensor chip being inserted into the reader.

The third compartment (3) is shown in FIG. 6B, in the embodiment shown it is a u-shaped well (15) sitting adjacent reaction chamber (9) and separated from same by shutter (11). Well (15) is ideally silicone moulded and sits firmly within the cartridge as a result of the compressive attachment of a rearward or outward sensor strip (16). Sensor strip (16), which forms an integral part of the cartridge, in one embodiment is attached to the cartridge via two spaced connectors (17) (FIGS. 6A & 6B). These connectors (17) may be heat stakes which are pressed flush to the main body of the cartridge (FIG. 6A). In an alternative embodiment the sensor strip (16) is attached to the cartridge using clip connectors (17a) and associated friction-fit mouldings in the cartridge (FIG. 6C). Sensor strip (16) is flush-mounted on the cartridge via connectors (17). The sensor strip (16) is configured so that a sensing window (18) therein is aligned with well (15). The silicone seal about well (15) prevents any solution entering the sensor strip (16) before the shutter (11) is opened. Further, in certain but not all embodiments the sensor strip is loaded with a binding agent, such as one or more receptors immobilised on the sensor chip surface, which bind with a target binding partner present in the sample to cause an electrical capacitive disturbance-caused by affinity binding of a target with the receptors -thus enabling the detection of an electrochemical impedance spectroscopy (EIS) assay.

It can be seen from the above description that the cartridge is made up of a number of component parts that fit together to provide a device with a single flow through pathway that is segmented into a number of parts each adapted to form part of the assay procedure undertaken when a sample is placed in the cartridge.

In use, we have found our cartridge is best when used with a solution volume greater than 100 μl and ideally 250 μl.

When the cap member (4) is pressed down onto the piercing blade (8), membrane (5) is broken and the substance in the first compartment (1), typically, but not exclusively, a buffer solution designed to extract (solubilise or suspend) a target (if present) from a sample placed within the cartridge, flows into the reaction chamber (9) of the second compartment (2). In certain embodiments this buffer may contain a binding agent such as an antibody for reacting with a target in said sample.

After the swab has been inserted into the second compartment (2) of the cartridge and brushed over the fins (11a) on the inner wall of shutter (11), the swab is then snapped at an upper break point and pushed within the reaction chamber, a covering (not shown) that fits over the cap member (4) may be provided to seal the cartridge.

FIGS. 7A-7D shows a reader (19) for use with the cartridge of the invention. It comprises a front central rectangular window (20) through which a reading can be viewed. It also comprises an aperture (21) adapted to receive the cartridge. Although not shown, it also comprises a mating hexagonal part, adapted for rotational mating with hexagonal fitting (14), which is functionally connected to a rotor whereby, after the cartridge is inserted in the reader (19), and parts on the sensor strip mate with parts in the reader, hexagonal fitting (14) can be rotated, thus rotating shutter (11) away from the opening in the reaction chamber (9) and so allowing the solution in the cartridge to flow into the third compartment (3) and onto the sensor strip (16). Moreover, the sensing window (18) in sensor strip (16) is aligned with the detecting feature of the reader so allowing the reader to assess the solution on the sensor strip (16) and provide a reading indicative of the presence or absence of the item in the sample to be detected. Notably, the reader may be configured to undertake any type of assay such as an optical assay or more preferably an electrochemical impedance spectroscopy (EIS) assay where electrical capacitive disturbance caused by affinity binding of an analyte onto a receptor immobilised on the sensor chip surface takes place.

It will be apparent from the above that the cartridge of the invention provides a perfectly sealed environment in which to conduct an assay for identifying an item within a sample provided on a swab. Moreover, the wand swab can be retained within the cartridge after use so that the cartridge and swab can be disposed of as one single item. Additionally, the wand swab can be made of a size to fit within the cartridge or provided with a wand break point whereby, after insertion in the cartridge, the wand can be broken, and the lower part of the broken wand and cartridge can be disposed of as one single item.

1. A cartridge for analysing a sample comprising a single flow path segmented into at least three compartments and comprising:
a first compartment comprising at least one substance for interacting with an item in a sample to be analyzed wherein said compartment is upstream of, and in fluid communication with, a reaction chamber but separated therefrom by a pierceable membrane or film;
a second compartment comprising the reaction chamber adapted to accommodate a sample swab wherein said compartment comprises at least one movable shutter to control the retention of substance and/or sample in said reaction chamber; and
a third compartment which is downstream of the reaction chamber, and through which said substance flows after having had contact with said sample, and which comprises a sensor strip on which said substance is analysed by a reader.

2. The cartridge according to claim 1 wherein said single flow path flows from, in use, the top to the bottom of the cartridge so that flow of said substance is aided by gravity.

3. The cartridge according to claim 1 wherein said first compartment comprises an aperture in fluid communication with atmosphere.

4. The cartridge according to claim 1 wherein said first compartment slidably engages within the cartridge and comprises an upper cap member which can be depressed to move further into the cartridge.

5. The cartridge according to claim 1 wherein adjacent said first compartment is a piercing member relatively and selectively movable so as to make piercing contact with the pierceable membrane and so allow the substance in the first compartment to flow through to the second compartment.

6. The cartridge according to claim 1 wherein said first compartment includes an abutment member that is adapted to engage with a co-operating member provided in the cartridge whereby depression of a first compartment cap member results in a downward action that terminates in engagement of the abutment member with the co-operating member.

7. The cartridge according to claim 1 wherein said second compartment comprises a reaction chamber whose cavity is adapted to accommodate a sample swab.

8. The cartridge according to claim 1 wherein said second compartment has a lower part that is fashioned to include at least one agitator.

9. The cartridge according to claim 1 wherein said agitator comprises at least one fin on an internal wall of the reaction chamber.

10. The cartridge according to claim 1 wherein said agitator is adapted for relative sideways movement of a back-and-forth nature with respect to said cartridge and/or said sample.

11. The cartridge according to claim 1 wherein said shutter is also adapted to move within said cartridge in an up-down, circular, sideways or twisting motion.

12. The cartridge according to claim 1 wherein, when the shutter is provided with an agitator, the shutter has two forms of motion a first form which enables mixing and a second form which allows the shutter to be opened and communication between compartments two and three.

13. The cartridge according to claim 12 wherein the first form of motion may represent a smaller form of the same movement as the second form of motion.

14. The cartridge according to claim 11 wherein the reaction chamber is mounted in the cartridge for more than one type of motion, twisting to enable mixing and up-down movement to enable the lifting of the shutter and the passage of the fluid from the reaction chamber to the third compartment.

15. The cartridge according to claim 1 wherein said sensor strip is mounted within said cartridge so as to be flush with the sides of same.

16. The cartridge according to claim 1 wherein said sensor strip includes a sensing window through which said substance can be assessed by the reader adapted to detect the content or form of said substance.

17. The cartridge according to claim 1 wherein said sensor strip includes members for making electrical contact with said reader.

18. The cartridge according to claim 1 wherein said sample is a biological sample or environmental sample.

19. The cartridge according to claim 1 wherein said substance is a reagent that can dissolve or suspend or bind whether reversibly or irreversibly, a target in said sample.

20. The cartridge according to claim 1 wherein said substance comprises an antibody or aptamer including fragments thereof; or an oligonucleotide or a ligand or a receptor that is a specific binding partner for a target in the sample.

21. A reader adapted to engage with said cartridge according to claim 1 whereby, when the cartridge is in the reader, a sensing window on the sensor strip is aligned with a part of the reader adapted to detect at least one feature of the substance indicative of the presence or absence of an item of interest in the sample.

22. The reader according to claim 21 wherein said cartridge and the reader are adapted to mate together in a complementary fashion.

23. The reader according to claim 21 wherein said reader comprises a mating member adapted for rotation whereby when engaged with said cartridge, at least a part of the cartridge inserted in the reader is made to rotate with respect to the remainder of the cartridge.

24. The reader according to claim 20 wherein said reader comprises a detector for detecting an item of interest in the substance.

25. A kit of parts comprising the cartridge according to claim 1 and a reader adapted to engage with said cartridge according to claim 1 wherein, when the cartridge is in the reader, a sensing window on the sensor strip is aligned with a part of the reader adapted to detect at least one feature of the substance indicative of the presence or absence of an item of interest in the sample.

26. The kit of parts according to claim 25 further comprising:
at least one wand swab provided with an upper break point in the wand.

27. The kit according to claim 25 wherein the reader is adapted to functionally communicate with said cartridge whereby reagents in said cartridge can be used to provide a point of care test (POCT) for identifying at least one item in a sample.

28. A method for performing sample analysis comprising:
i) inserting a sample swab into a part of a single flow path in a cartridge wherein said single flow path is segmented into at least three compartments comprising:
a first compartment comprising at least one substance for interacting with an item in a sample to be analyzed wherein said compartment is upstream of and in fluid communication with a reaction chamber but separated therefrom by a pierceable membrane or film;
a second compartment comprising the reaction chamber adapted to accommodate the sample swab wherein said compartment comprises at least one movable shutter to control the retention of substance and/or sample in said reaction chamber; and
a third compartment which is downstream of the reaction chamber, and through which said substance flows after having had contact with said sample, and which comprises a sensor strip on which said substance is analysed by a reader;
ii) releasing said substance from said first compartment by piercing said membrane or film so that said substance flows into said second compartment;
iii) optionally, mixing said substance with said sample;
iv) moving said shutter of said second compartment whereby said substance flows into said third compartment and onto said sensor strip; and
v) placing said cartridge in a reader adapted to detect a feature of said substance indicative of an item of interest in said sample and where said feature is recognized concluding said item of interest is present in said sample.
